(19) United States
(12) Patent Application Publication
(10) Pub. No.: US 2012/0168409 A1
(43) Pub. Date: Jul. 5, 2012

(54) Method and Arrangement for the Operation of Welding Controllers

(75) Inventors: Tobias Schwarz, Bad Koenig (DE); Dhruv Kalia, Bangalore (IN)

(73) Assignee: Robert Bosch GmbH, Stuttgart (DE)

(21) Appl. No.: 13/337,214

(22) Filed: Dec. 26, 2011

(30) Foreign Application Priority Data
Dec. 30, 2010 (DE) 10 2010 056 496.6

(51) Int. Cl. B23K 11/00

(52) U.S. Cl. 219/117.1; 219/78.01

(57) ABSTRACT

A resistance welding device is disclosed in which one and the same operator control device can be used to flexibly operate a plurality of welding controllers simultaneously or a plurality of operator control devices can be used to flexibly operate only one and the same welding controller simultaneously.

This application claims priority under 35 U.S.C. §119 to patent application no. DE 10 2010 056 496.6, filed on Dec. 30, 2010 in Germany, the disclosure of which is incorporated herein by reference in its entirety.

### BACKGROUND

The disclosure relates to a resistance welding device and to a method for the operation of such a device.

Frequently, these arrangements comprise a multiplicity of welding controllers and operator control devices. Each operator control device runs a software application which can be used to configure and operate a welding controller.

The software applications are managed and maintained on the individual operator control devices separately. When an update for the operator control software is imminent, this needs to be performed on each operator control device separately. The required computation power and the memory requirements for the operator control software mean that it is necessary to provide correspondingly powerful industrial PCs as operator control devices. Both data backup and updates for the operator control software become correspondingly complex, since every single industrial PC needs to be maintained separately.

The disclosure aims to simplify the handling of such installations for the user and help to save costs for care and maintenance.

### SUMMARY

This is achieved by means of the method according to the disclosure and the apparatus according to the disclosure.

The disclosure relates to a resistance welding device having a plurality of physically spaced welding controllers and a plurality of physically spaced operator control devices. For the operation of this arrangement, a central computation device is provided. The central computation device connects the welding controllers and the operator control devices. The central computation device can be used to implement communication between the operator control devices and the welding controllers. The method according to the disclosure allows the operator control devices and the welding controllers to be arbitrarily associated with one another by means of the central computation device, as a result of which a single operator control device can be used to operate a plurality of welding controllers simultaneously or a plurality of operator control devices can be used to operate one and the same welding controller simultaneously. This is achieved by virtue of the central computation device setting up and coordinating the communication links which are required for communication between operator control devices and welding controllers.

It is possible for any desired welding controller to be addressed from any desired location at which there is an operator control device. This facilitates the access to the individual welding controllers and saves transit times for the users of the installation. As a central EDP component, the computation device can easily be incorporated into an existing IT infrastructure and cared for and maintained centrally by the IT personnel.

Preferably, the operator control devices are configured as clients and the central computation device is configured as a server. The operator interfaces required for the operation of the welding controllers are executed on the central computation device in the form of individual instances of a central piece of operator control software for welding controllers using the computation power of the central computation device. The number of instances running in parallel corresponds to the number of operator control devices actually used.

The operator control devices are used as an operator terminal and merely provide the operator of the installation with access to the operator interface for the purpose of configuring the welding controllers, without themselves needing to procure the overall computation complexity which is required for the operation of the operator control software. The actual computation-intensive and memory-intensive operator control software is in place only once and is executed on the central computation unit. It can therefore be maintained and updated centrally without needing to touch the computation units of the operator control devices. Data backup processes can likewise take place at a central location. This reduces the complexity for starting up and for using the installation to a significant degree.

For each operator control device, a separate instance of the central operator control software for welding controllers is started, preferably automatically, on the central computation device. An instance within the context of the disclosure is understood to mean a program which can be executed automatically after starting and which is based on an executable code which can be started repeatedly on the same computation unit, each program then being able to be executed automatically by itself and independently of the other program. A plurality of instances may exist simultaneously beside one another and can communicate with welding controllers independently of one another. For all instances, there is a shared database available which can be used individually by the instances in each case independently of the other instances.

The user interface of an instance and the behavior of this instance can be controlled by the operator using the operator control devices. The operator can use an operator control device to select which welding controller he wishes to address using the instance. The operator control device is therefore used to implement remote access to the instance executed on the central computation device or the welding controller which can be addressed by means of the instance. The user can therefore configure and operate the welding controllers remotely, without needing to be in the vicinity of the central computation device or one of the welding controllers.

Communication between a welding controller and one or more operator control devices involves an explicit connection identifier being stored for each instance of the central operator control software in a data memory in the central computation unit by the central operator control software after the instance has registered with the central operator control software. The operator control devices involved in the communication can therefore be explicitly identified at any time during ongoing communication and can be associated with that welding controller with which they are currently communicating.

An operator control device, upon setup of a communication link to the operator control software, sends an explicit operator control device identifier, inter alia, which remains unchanged during the communication and becomes part of the connection identifier. The operator control software similarly allocates an explicit order identifier for a command which is sent to a welding controller by the operator control device, said order identifier also becoming part of the connection identifier.

Conversely, a data record transmitted to an operator control device by the welding controller is transmitted to the operator control device using the operator control device identifier and the order identifier.

These practices described above facilitate the internal management and coordination of the active communication links between operator control devices and welding controllers by means of the computation device and the software executed thereon. At any time, it is an explicit certainty which operator control device has sent a command relevant to the operation of the welding controller to which welding controller and which operator control device is possibly still awaiting a response.

When the communication has concluded, the connection identifier is removed from the data memory of the central computation unit by the central operator control software, so that memory is cleared for new tasks. The instances are then deregistered from the communication with the operator control software.

The device according to the disclosure comprises a resistance welding device having a plurality of physically spaced operator control devices for the operation of welding controllers and a plurality of physically spaced welding controllers and also a central computation device by means of which the welding controllers and the operator control devices are connected to one another and by means of which communication between the operator control devices and the welding controllers can be implemented. In this case, the central computation device comprises a means which can be used to arbitrarily associate the operator control devices and the welding controllers with one another. The same operator control device can therefore also be used to operate a plurality of welding controllers simultaneously or a plurality of operator control devices can also be used to operate only one and the same welding controller simultaneously. The then requisite coordination of the communication links is ensured by the aforementioned method steps. The means is a software resource which is executed by means of the computation device and is intended for the operation of welding controllers. The software resource comprises a database, an executable main program and a plurality of flexibly callable instances of the program, which can dynamically register and deregister with the program.

The operator control devices are configured as clients, and the central computation device is configured as a server for the clients. The aforementioned software resource for the welding controllers is stored on the central computation device. The instances of the software resource which are executed on the central computation device are associated with individual operator control devices. Each operator control device stores a software resource which can be used to remotely control the instances of the software resource using the operator control devices and to present them on the operator control devices.

The database provided is an SQL database which is installed on the server. The instances use SQL to access this database, extract data therefrom and store data therein. The data themselves are parameterization data for the welding controllers that are to be configured and operated, for example.

The advantages of this arrangement are primarily very flexible access management between the operator control devices and the welding controllers. Maintenance work can be carried out with significantly reduced complexity. The personnel responsible for controlling the welding controllers is relieved of load and therefore has capacities free for ensuring the welding tasks.

The database and the configuration means can be managed and maintained centrally on the central computation device, this not needing to be done on each operator control device separately. The central computation device can easily be integrated into an existing IT infrastructure. Both the data backup and updates for the configuration means can be effected with considerably reduced complexity and can also be accomplished by the IT personnel. The employee responsible for controlling the welding controllers is thereby relieved of such work and therefore has capacities free for ensuring the welding tasks.

The software control means of an operator control device may be a much simpler software tool (e.g. terminal program), for example, which is suitable for connecting to the server and communicating with the software resource and also visually displaying the interface thereof on the operator control device. The demands on the performance of the operator control devices are thereby reduced, because these do not need to provide complex software tools for the welding controller or comprehensive databases. It suffices to provide extremely simple hardware systems for this purpose. This saves costs. It is preferred if the computation devices and the operator control devices are connected to one another by means of a wired communication network, particularly one based on Ethernet technology, and/or by means of a wireless communication network. Incorporation into existing data network structures is therefore a simple matter using standard means such as switches, router or bridges.

### DETAILED DESCRIPTION OF THE DRAWINGS

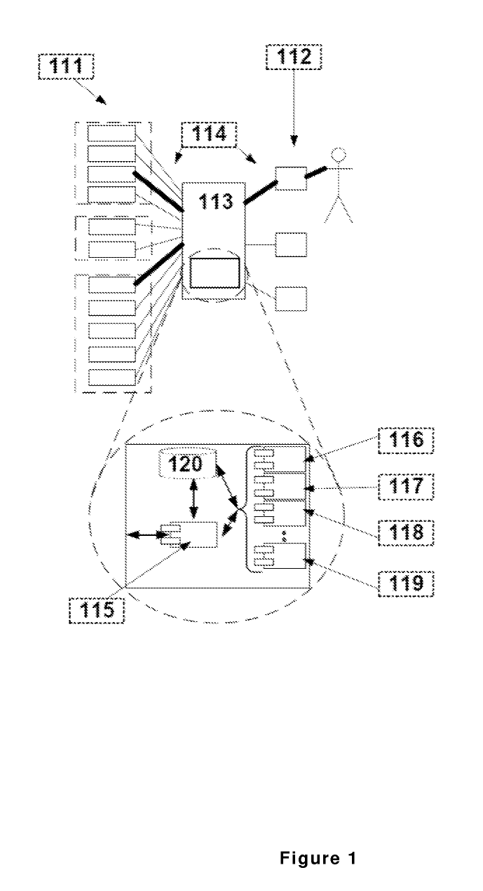

FIG. 1 shows a highly schematic view of an installation according to the disclosure.

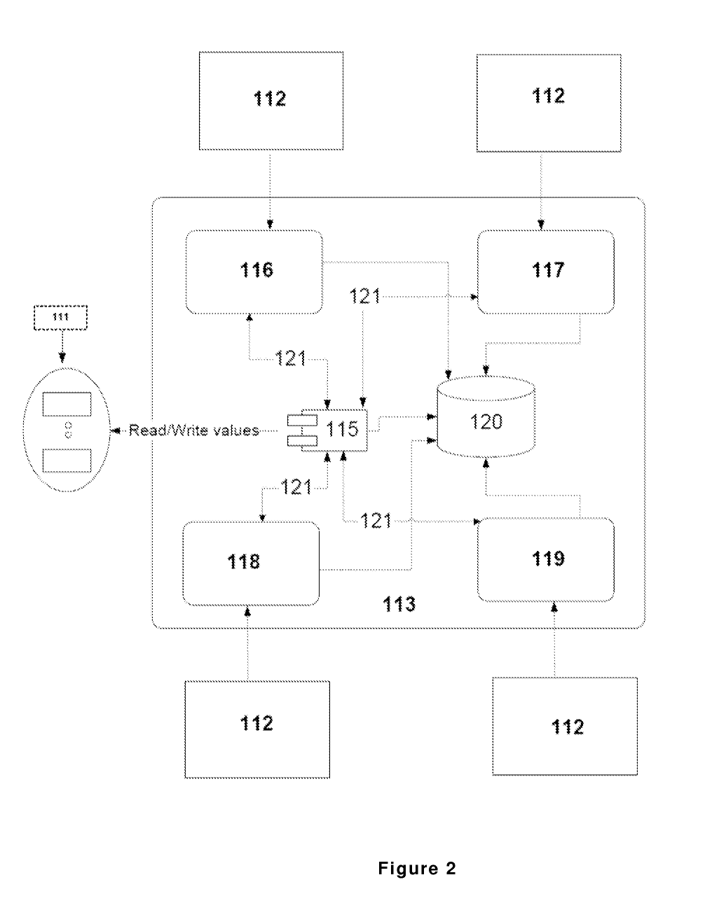

FIG. 2 shows communication links which have been set up.

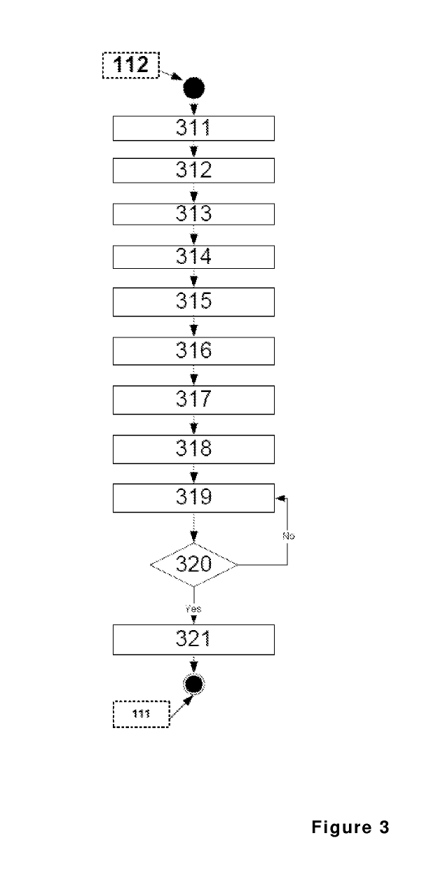

FIG. 3 shows the flow of data for an input.

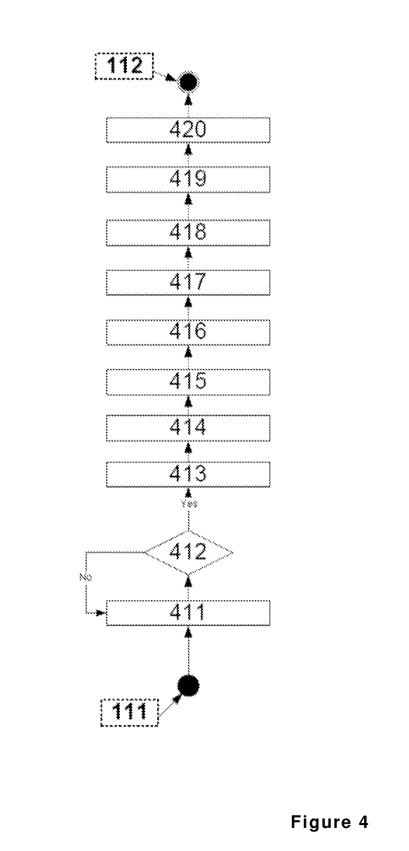

FIG. 4 shows the converse flow of data from that shown in FIG. 3.

### DETAILED DESCRIPTION

FIG. 1 shows the arrangement according to the disclosure in the form of three operator control devices 112 which, as already described further above, can start on a separate instance 116, 117, 118, 119 of the central operator control software 115 executed on the central computation device 113 and can therefore use the central computation device 113 and a wireless or wired communication network 114 to access the welding controllers 111 which are associated with the operator control devices 112 or which can also be subsequently associated with the operator control devices 112 in the course of operation. The solution shown in this case can be regarded as highly schematic and exemplary and is not intended to restrict the disclosure to the features shown here. For the operator control software 115, a database 120 is available which stores all the data which are required for managing the welding controllers.

FIG. 2 likewise shows a resistance welding device having a plurality of physically spaced welding controllers 111 and a plurality of physically spaced operator control devices 112 for the operation of the welding controllers 111. The operation is effected by means of the central computation device 113, by means of which the welding controllers 111 and the operator control devices 112 are connected and by means of which communication between the operator control devices 112 and the welding controllers 111 is implemented. While they are operating, the operator control devices 112 and the welding controllers 111 can be arbitrarily associated with one another by means of the central computation device 113. A single operator control device 112 can also be used to address a plurality of welding controllers 111 simultaneously. Similarly, a plurality of operator control devices 112 can also be used to operate only one and the same welding controller 111 simultaneously by virtue of the central computation device 113 setting up and coordinating the communication links 121 which are required for communication between operator control device 112 and welding controller 111 using the instances 116, 117, 118, 119.

The operator control devices 112 are configured as clients. The central computation device 113 is configured as a server. The operator interfaces required for the operation of the welding controller 111, in the form of individual instances 116, 117, 118, 119 of the central operator control software 115 for welding controllers, are executed using the computation power of the central computation device 113. The number of instances 116, 117, 118, 119 running in parallel normally corresponds to the operator control devices 112 actually used. Each operator control device 112 is assigned an instance. The user interface of the instances 116, 117, 118, 119 and the behavior of these instances 116, 117, 118, 119 can be controlled by means of the operator control devices 112. Each operator control device 112 can therefore be used to implement remote access to the central computation device 113 using a terminal program (not shown) executed on the operator control device 112.

In the course of communication between a welding controller 111 and one or more operator control devices 112, a connection identifier 121 is stored in a data memory in the central computation device 113 for all operator control devices 112 involved in the communication. The storage takes place as soon as an instance 116-119 of the central operator control software registers with the central operator control software. All operator control devices 112 involved in the communication or their associated instances can therefore be explicitly identified at any time during ongoing communication and can easily be associated with that welding controller 111 with which they are communicating.

When the respective communication links between operator control device 112 and welding controller 111 are terminated, the connection identifiers 121 are removed from the data memory in the central computation unit 113 and the data memory is therefore cleared again for implementing other connections.

FIG. 3 shows the flow of data for an input using an operator control device 112. An input 311 on the operator control device 112 first of all prompts the allocation of an operator control device identifier 312. An order identifier 313 is then allocated. Both, the operator control device identifier 312 and the order identifier 313, form the connection identifier (not shown) already described further above. The connection identifier is stored in the memory area of the central computation device, for example using an association table (FIFO principle), in a further step 314. The order identifier 313 is transferred to an order identifier management unit in a further step 315. The order identifier management unit caters for execution 316 of the orders identified by means of the order identifier 313. To this end, the connection identifier is converted 317 into a transmission protocol provided for transmission purposes and the data stream is forwarded 318 to a communication routine. The communication routine 319 monitors the communication channel by checking whether it is ready 320 for the transmission of data. If this is case, the protocol is sent to that controller 111 or those controllers 111 for which the order is intended.

FIG. 4 shows the flow of data in the case of acknowledgement of information for an operator control device 112 from a controller 111.

Data coming from a controller 111 which are intended for an operator control device 112 are converted by the firmware of the controller 111 into a protocol provided for transmission purposes and are transmitted to the software control means by means of the central computation device 113.

The communication routine monitors 411 the communication channel between operator control software and controller firmware by checking whether said communication channel is ready for the transmission of data and whether data are due. If data are received 412, they are transferred 413 to the order identifier management unit already described for FIG. 3. To this end, the connection identifier and the order identifier are first of all extracted 414 from the protocol. The order identifier management unit then caters for buffer storage 415 (e.g. FIFO principle) and for execution 416 of the orders identified by means of the order identifier.

The connection identifier extracted by means of the execution steps 417-419 is compared with the one in a memory area of the central computation device, for example using data stored in an association table. At the same time, the association table is used to ascertain which operator control device 112 is associated with the connection identifier (see description of FIG. 3). The data intended for the operator control device 112 are then forwarded 420 thereto and the referencing between the connection identifier, the operator control device and the order within the memory is erased, so that the memory is now available for managing new communication links.

What is claimed is:

1. A method for the operation of a resistance welding device having a plurality of physically spaced welding controllers and a plurality of physically spaced operator control devices for the operation of the welding controllers by means of at least one central computation device, by means of which the welding controllers and the operator control devices are connected and by means of which communication between the operator control devices and the welding controllers can be implemented, wherein the operator control devices and the welding controllers can be arbitrarily associated with one another by means of the central computation device, as a result of which the same operator control device can also be used to operate a plurality of welding controllers simultaneously or a plurality of operator control devices can also be used to operate only the same welding controller simultaneously by virtue of the central computation device setting up and coordinating the communication links which are required for communication between operator control devices and welding controllers.

2. The method according to claim 1, wherein the operator control devices are configured as clients and wherein the central computation device is configured as a server, wherein the operator interfaces which are required for the operation of the welding controllers are executed in the form of individual instances of a central piece of operator control software for welding controllers using the computation power of the central computation device and wherein the number of instances which can be executed in parallel corresponds to the number of operator control devices which are actually used.

3. The method according to claim 2, wherein each operator control device has an associated instance, wherein the user interface of an instance and the behavior of this instance are controlled by means of the operator control device by virtue of the operator control device being used to implement remote access to the central computation device.

4. The method according to claim 1, wherein communication between a welding controller and one or more operator control devices involves an explicit connection identifier being stored in a data memory in the central computation unit, as a result of which the operator control devices involved in the communication can be explicitly identified at any time during ongoing communication and can be associated with that welding controller with which they are communicating.

5. The method according to claim 4, wherein an operator control device, upon setup of a communication link to the operator control software, sends an explicit operator control device identifier which remains unchanged during the communication and becomes part of the connection identifier.

6. The method according to claim 5, wherein the operator control software allocates an explicit order identifier for a command which the operator control device intends for a welding controller and this order identifier likewise becomes part of the connection identifier.

7. The method according to claim 6, wherein the operator control software uses the operator control device identifier and the order identifier to transmit a data item, intended to be transmitted to an operator control device by the welding controller, to the operator control device.

8. The method according to claim 4, wherein upon termination of the communication link the connection identifier is removed from the data memory in the central computation unit.

9. A resistance welding device comprising a plurality of physically spaced operator control devices for the operation of welding controllers, a plurality of physically spaced welding controllers and also a central computation device by means of which the welding controllers and the operator control devices are connected to one another and by means of which communication between the operator control devices and the welding controllers can be implemented, wherein the central computation device comprises a mechanism configured to arbitrarily associate the operator control devices and the welding controllers with one another, as a result of which the same operator control device can also be used to operate a plurality of welding controllers simultaneously or a plurality of operator control devices can be used to operate only one and the same welding controller simultaneously.

10. The device according to claim 9, wherein the operator control devices are configured as clients and wherein the central computation device is configured as a server for the clients, wherein a software resource for the welding controllers is stored on the central computation device, wherein instances of the software resource which are executed on the central computation device can be associated with individual operator control devices.

11. The device according to claim 10, wherein each operator control device stores a software control means which can be used to remotely control instances of the software resource using the operator control device.
